(19) United States
(12) Patent Application Publication
(10) Pub. No.: US 2008/0136586 A1
(43) Pub. Date: Jun. 12, 2008

(54) VERIFICATION METHOD AND SYSTEM

(76) Inventors: Michael Backes, Rentrisch (DE); Thomas R. Gross, Zurich (CH); Guenter Karjoth, Waedenswil (CH); Luke J. O'Connor, Adliswil (CH)

Correspondence Address: LAW OFFICE OF IDO TUCHMAN (YOR), 82-70 BEVERLY ROAD, KEW GARDENS, NY, 11415, US

(21) Appl. No.: 11/925,182

(22) Filed: Oct. 26, 2007

(30) Foreign Application Priority Data
Oct. 27, 2006 (EP) 06123078.5

(51) Int. Cl. H04Q 5/22

(52) U.S. Cl. 340/5.8; 340/10.1

(57) ABSTRACT

A verification method, system and computer program. The method includes the steps of reading first summary information related to a first group of tags, reading tag information for each tag of a second group of tags, computing second summary information based on the read tag information of the second group of tags, comparing the first summary information and second summary information, and verifying whether the first group of tags and the second group of tags are identical based on the comparison.

### CROSS-REFERENCE TO RELATED APPLICATIONS

This application claims priority under 35 U.S.C. § 119 to European Patent Application No. 06123078.5 filed Oct. 27, 2006, the entire text of which is specifically incorporated by reference herein.

### BACKGROUND OF THE INVENTION

The present invention relates to a method for verifying whether a first and second group of tags are identical. The present invention further relates to a verification system, a computer program and a computer program product adapted to perform a verification method.

Increasingly tags, like barcodes and so called RFID (radio frequency identifier) tags, are used to identify and classify goods along a supply chain, i.e. on their way from a manufacturer to the customer.

RFID tags in particular allow to track individual goods, as they provide easy, cost effective means of attaching a unique tag to each item manufactured. In practice, RFID tag information usually comprises a 64, 96 or 128 bit identifier, which can be broken down into parts related to the manufacturer, the product class, the product type and a unique serial number.

As RFID tags become cheaper, it becomes economically viable to tag even relatively cheap goods, such as individual food and drink items, for example cans containing fizzy drinks. Along the supply chain, such comparatively cheap items are usually handled in bulk quantities, for example in form of crates, shrink packaging, palettes and the like, comprising a large number of individual items.

One challenge of supply chain management comprises the identification of lost, replaced or added items within a relatively large group of items. The event of items getting lost, stolen or damaged is sometimes referred to as “shrinkage”, but other events like malicious or unintentional inclusion of additional items is also of interest and should be detected.

One way of verifying the completeness and correctness of a given group of items comprises to read an RFID tag of each item and to compare it with a list of expected RFID tags made available electronically, i.e. over a data network, from a supplier of the group.

However, such an approach requires the exchange of large amounts of data and thus may not be applicable at all locations, for example at remote or particular small locations along the supply chain. Also, such an approach requires that an online database is present in the verification.

Consequently, there exists a need for improved verification methods and systems.

### SUMMARY OF THE INVENTION

According to an embodiment of a first aspect of the present invention, a verification method is provided. The method includes the steps of: reading first summary information related to a first group of tags, reading tag information for each tag of a second group of tags, computing second summary information based on the read tag information of the second group of tags, comparing the first and the second summary information, and verifying whether the first and the second group of tags are identical based on the comparison.

By only reading first summary information related to a first group of tags, the amount of data needed to be transferred for verification is reduced. At the receiving end, only this first summary information needs to be read, and can then be compared with second summary information computed locally based on the tag information read from the individual items.

According to a preferred embodiment of the first aspect, the first summary information is read from a master tag associated with the first group of tags. Consequently, the so called master tag comprising the first summary information can be included with a shipment of a bulk quantity of items, for example attached to a crate or palette. In this case, the master tag can store the summary information about the first group of tags, which are expected to be included in the crate or palette. As a result, no online connection is required at either end, i.e. verification can be performed offline.

According to an embodiment of the first aspect, the first and second summary information is based on at least one hash function resulting in a hash value for each tag information. By using hash values instead of the tag information itself, the requirement for data storage capacity can be greatly reduced. According to a further embodiment of the first aspect, the at least one hash function is a predefined hash function. If the hash function is predefined, for example by way of standardization, no further information relating to the hash function needs to be provided for verification.

According to a further embodiment of the first aspect, the at least one hash function is a parameterized hash function and at least one parameter used by the hash function is comprised in the first summary information. By using and storing at least one parameter for parameterizing the hash function, it can be adapted to the first group of tags without greatly increasing storage requirements of the first summary information.

According to a further embodiment of the first aspect, the at least one hash function is a perfect hash function resulting in a unique hash value for each tag of the first group of tags, and, in the step of computing the second summary information, a collision of hash values computed for two different tags of the second group of tags indicates an addition of an extra tag to the second group of tags. By using a perfect hash function, which will be collision free in the first group of tags, i.e. the group of tags intended to be included in a particular shipment, any collision detected on the receiving side indicates that at least one extra tag has been added to the shipment, such that detection can be performed efficiently.

According to a further embodiment of the first aspect, the first and second summary information comprises a multiplicity of values associated with a multiplicity of sub-groups of the first group of tags and second group of tags, respectively, in the step of comparing, pairs of values from the first and second summary information are compared with each other, and, in the step of verifying, identical and modified pairs of values of the first and second summary information are identified, corresponding to unmodified and modified pairs of sub-groups of the first and second group of tags, respectively. By including a multiplicity of values associated with a multiplicity of sub-groups of the first and second groups of tags in the summary information, the correctness of individual sub-groups of the second group of tags can be verified. Consequently, it becomes possible to identify what part of the second group of tags has being tampered with.

According to a further embodiment of the first aspect, the first summary information comprises data values related to at least a sub-group of nodes of a first hash tree, in the step of computing the second summary information, at least one second hash tree is computed, and, in the step of comparing, corresponding tree nodes of the first and second hash tree are compared with each other. Computing and comparing nodes of a hash tree allows to more efficiently detect and locate modified sub-groups in the second group of tags based on tree traversal algorithms.

According to a further embodiment of the first aspect, the first summary information comprises data values related to at least a sub-group of nodes of at least two different first hash forests with a first and second tree level, the step of computing is performed at least twice for computing at least two different second hash forests with the first and second tree level, the step of comparing is performed at least twice using pairs of first and second hash forests with the first and second tree level, respectively, resulting in first and second probability values for different sub-groups of the second group of tags being modified, and, in the step of verifying, a combined probability value for each tag of the second group of tags is being computed based on interference of the first and second probability values associated with a tag to be verified. Computing a combined probability value for each tag to be verified based upon an interference of first and second probabilities allows to detect missing, changed or added tags with high likelihood at reduced storage requirements.

According to an embodiment of a second aspect of the present invention, a verification system comprising a tag reader, adapted to wirelessly read first summary information related to a first group of tags from a master tag and tag information from each tag of a second group of tags, and a verifier operationally connected to the tag reader, is provided. The verifier is further adapted to perform the steps of reading the first summary information from the master tag, reading tag information from the tags of the second group of tags, computing second summary information based on the read tag information, comparing the first and second summary information, and verifying whether the first and second group of tags are identical based on the comparison. By providing a verification system comprising a tag reader and a verifier, a method embodying the present invention can be performed by the verification system.

According to a further embodiment of the second aspect, the verification unit is further adapted to detect the absence of a tag from the second group with respect to the first group, and, on detection of the absence of at least one tag, the reader is repositioned with respect to the second group of tags for further reading of the tags. By detecting an absence of at least one tag and repositioning the reader in response to it, errors caused by incomplete reading of the second group of tags can be corrected by bringing the reader into a new position, such that, on a subsequent read, further tags can be identified.

According to an embodiment of a third aspect of the present invention, a computer program product comprising a computer readable medium embodying program instructions executable by a processing device of a verification system is provided. The program instructions comprise steps required to perform a verification method in accordance with an embodiment of the first aspect of the present invention. It may also comprise steps of the preferred embodiments of the first aspect.

### BRIEF DESCRIPTION OF THE SEVERAL VIEWS OF THE DRAWINGS

The invention and its embodiments will be more fully appreciated by reference to the following detailed description of presently preferred but nonetheless illustrative embodiments in accordance with the present invention when taken in conjunction with the accompanying drawings.

FIG. 1 is a schematic diagram of a verification system;

FIG. 2 is a schematic diagram of a first group of tags and a second group of tags;

FIG. 3 illustrates a method for distributing elements of a first group of tags into different buckets using a hash function;

FIG. 4 is a schematic diagram of a so called Merkle hash tree;

FIG. 5A to FIG. 5C are a schematic diagram of hash trees with different tree levels;

FIG. 6A and FIG. 6B show the discriminatory power of the proposed scheme for different hash value length.

### DETAILED DESCRIPTION OF THE INVENTION

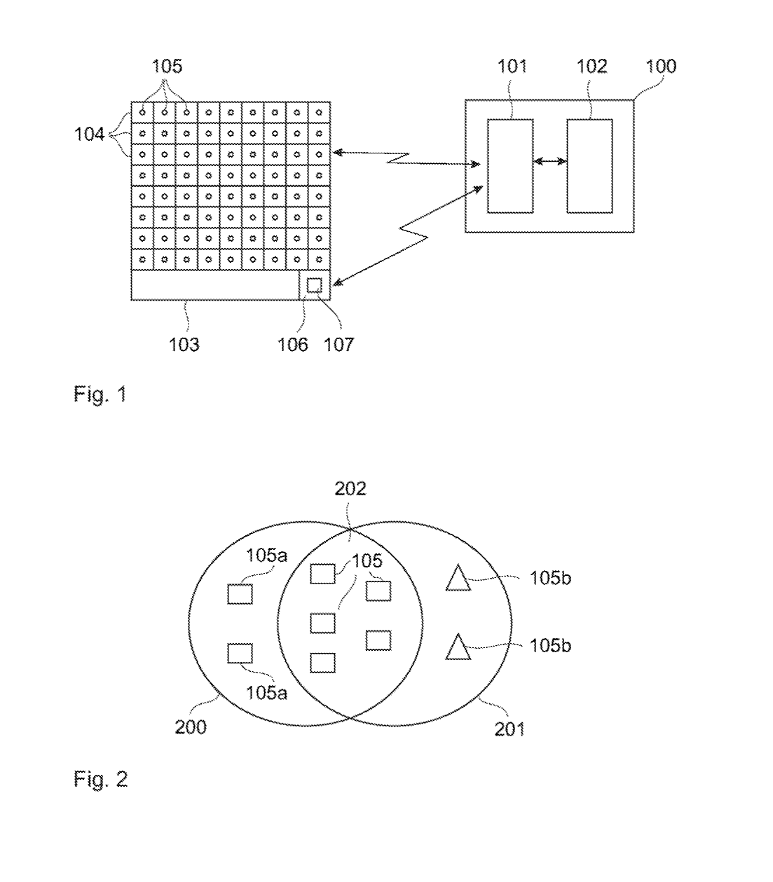

FIG. 1 shows a verification system 100 comprising a tag reader 101 and a verifier 102. The verification system 100 is positioned next to a palette 103 carrying a multiplicity of items 104. Each item 104 has a tag 105 attached to it. The tag 105 may be a so called primitive or simple tag comprising only a unique identifier and limited logic circuitry. Such tags, for example so called RFID class 0 tags, are widely available and currently cost a few cents only.

In addition, a so called master tag 106 is attached to the palette 103. The master tag 106 comprises first summary information 107, summarizing the tag information of all tags 105 attached to items 104 that should be on the palette 103. The master tag has additional capabilities, for example a greater storage or computing capacity. Such tags, for example so called RFID class 1 or 3 tags, are usually more expensive, currently costing a few dollars, and thus will only be attached to more valuable items, or, as in the presented embodiment of the invention, to a large quantity of cheaper items 105.

The tag reader 101 is adapted to communicate with both kind of tags, the tags 105 attached to the items 104 and the master tag 106 attached to the palette 103. In addition, the tag reader 101 is connected to the verifier 102 to allow information obtained by the tag reader 101 to be processed by the verifier 102.

In practice, the tag reader 101 may be a standard RFID tag reader with an external data interface and the verifier 102 may be a handheld computer system, such as a laptop or a PDA. Of course, the tag reader 101 and the verifier 102 can also be comprised in a single device. Parts or all of the verification system 100 may be implemented in hardware or software. In particular, a computer program product comprising a computer readable medium embodying program instructions executable by a processing device of the verification system 100 may be part of the verification system 100.

FIG. 2 shows a schematic diagram of a first group of tags 200 and a second group of tags 201. The first group of tags 200 comprises those tags 105 that are supposed to be comprised in a predefined group. For example, the first group of tags may comprise the tags 105 attached to items 104 on a palette 103 when released by a manufacturer of the items 104. In contrast, the second group of tags 201 comprises those tags 105 that are actually read by the tag reader 101 of the verification system 100. For example, the second group of tags 201 could comprise the tags 105 attached to items 104 received by a retailer.

On the way from the manufacturer to the retailer, some tags 105a might have been lost or stolen or otherwise removed, or simply not being read successfully by the reader 101, such that, in the diagram shown in FIG. 2, two tags 105a of the first group of tags 200 are not included in the second group of tags 201. In addition, in the example presented, two tags 105b have been added to the second group of tags 201, which were not included in the first group of tags 200. For example, items 104 supplied by a malicious party could have been included in the shipment. For ease of representation, such added tags 105b are represented by a triangle, whereas all other tags 105, which were included in the first group of tags 200 are represented by a square.

Most tags 105 are included in the intersection 202 of the first group of tags 200 and the second group of tags 201. In practice, one would expect that the majority of items 104 carrying tags 105 output by a manufacturer will still be present on the palette 103 once it is delivered to a retailer.

In the presented example, the master tag 106 has added storage capabilities in comparison with the simple tags 105. There are RFID tags available, which have a storage capacity of several kilobytes. However, including all tag information of all tags 105 comprised in a first group of tags 200 may still exceed the storage capacity of the master tag 106. For this reason, it is advantageous to compress the first summary information 107 about the first group of tags 200 stored in the master tag 106 by some means.

One way of compressing data into a fixed length representation is provided by the use of hash functions. A hash function takes an input value of finite or infinite length and computes, in an efficient way, based on the input value an output or so called hash value, which has a finite length and is usually shorter than the length of the input value. A further property of many hash functions is that a small change in the input value will result in an unpredictable change of the output value such that, in general, it will be hard to generate an input value which will result in a desired output value. So called cryptographic hash functions employed in the art are collision-resistant, that is, it is infeasible for an malicious party to change the input value in a way such that the same output value occurs.

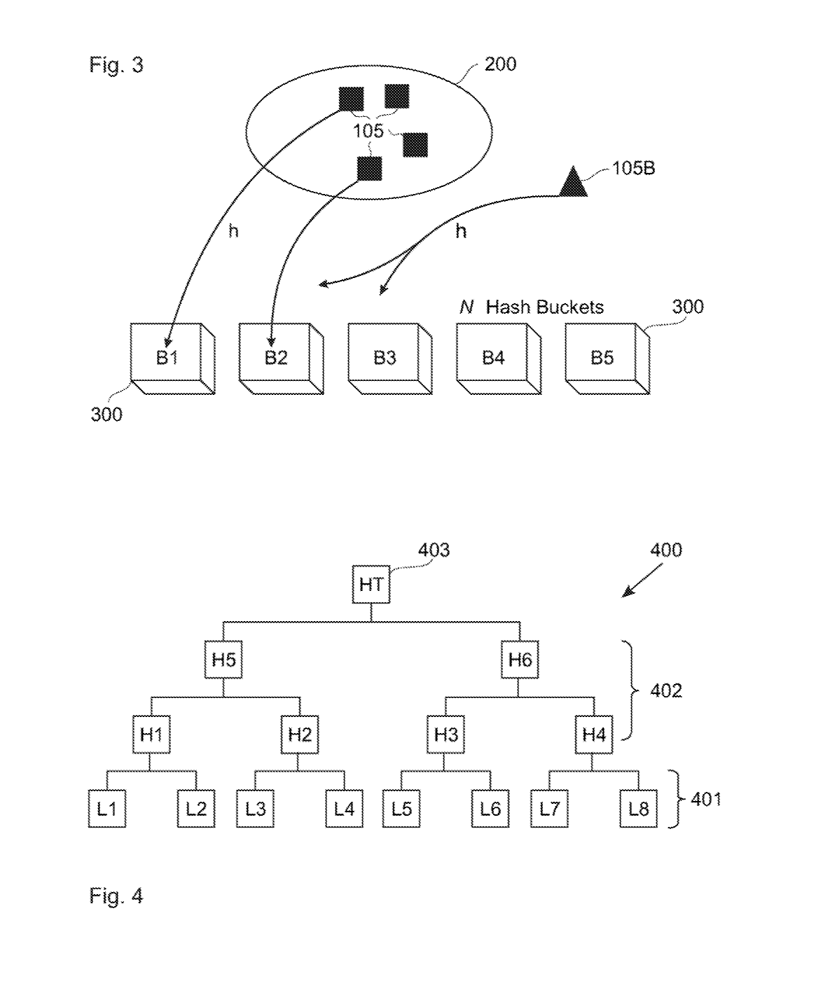

FIG. 3 shows a distribution of tags 105 of the first group of tags 200 using a first hash function h to a group of N so called hash buckets 300. The buckets 300 are associated with a particular hash value, such that tags 105 resulting in that hash value will be put into the associated buckets 300, labeled B1 to B5.

A particular kind of hash functions are so called perfect or collision free hash functions. A perfect hash function is characterized in that each element of a given group or domain is distributed into a different bucket 300 or hash value. In the example presented in FIG. 3, a perfect hash function with respect to the first group of tags 200 is used as first hash function h. Thus, the distribution indicated by the two arrows leading from the first group of tags 200 to the bucket 300 is injective.

There are methods known in the art that allow constructing a hash function for a given group, such that the resulting hash function is free of collisions for this very group as disclosed in an article by Fox, Heath, Chen and Daoud titled “Practical minimal perfect hash functions for large databases”, CACM, 35(1):105-121, January 1992. However, taking some arbitrary input value, for example the tag information of an added tag 105b, which was not included in the first group of tags 200 used to generate the first hash function h, this element will be distributed with a pseudorandom probability to any one bucket 300. Depending on the likelihood of one particular bucket 300 already containing one tag 105 of the first group of tags 200, a collision may occur, which indicates that at least one added tag 105b is present. Minimal hash functions are particular useful in this context. A perfect hash function is called minimal, if the output set has the same size as the input set. That is, the number of buckets 300 is equal to the number of tags 105 in the first group of tags 200, such that any added tag 105b will result in a collision.

Consequently, by simply computing the hash values of tag information of tags 105 comprised in the second group of tags 201 using a first hash function h defined by parameters or hash keys comprised in the first summary information 107, the inclusion of added tags 105b can be detected.

Hashing the second group of tags 201 into buckets 300 creates an ordered structure associated with the second group of tags 201, which can be used for further validation steps. In particular, by ordering the buckets 300, for example in ascending order of associated hash values, a fixed order can be imposed on the second group of tags 201, even in cases where tags 105a of the first group of tags 200 are missing from it. Based in this ordering, further summary information can be derived, allowing detection of added and removed tags 105b and 105a, respectively, as set out below.

According to a first variant, a so called Merkle tree is computed based on the ordered second group of tags 201. FIG. 4 shows a Merkle hash tree 400. The hash tree 400 shown in FIG. 4 represents a binary tree. Its leaf nodes 401, labeled L1 to L8, comprise the tag values 105 of the second group of tags 201 and correspond to buckets 300 associated with hash values of the first hash function h used to hash the tags 105 of the first group of tags 200. The buckets 300 are ordered using a predefined attribute, for example in the natural order of the associated hash values of the first hash function h.

Above each group of two leaf nodes 401 is an internal node 402 labeled H1 to H4, which summarizes the two nodes attached to it by means of a second hash function g. For example, the second hash function g may compute the hash value H1 based on the concatenation of the two tags 105 labeled D and B respectively comprised in leaf nodes L1 and L2, i.e. H1=g(D∥B). Alternatively, tags 105 may be hashed using the second hash function g on their own first, i.e. H1=g(g(D)∥g(B)). For higher levels nodes, the hash values of lower level nodes are concatenated, i.e. H5=g(H1∥H2). This is repeated for all internal nodes 402 of the hash tree 400, until only a single root node 403 remains. The root node 403 is labeled with HT in FIG. 4.

Hash trees 400 may be computed for the first group of tags 200 and the second group of tags 201 in a similar manner. For the sake of distinction, these will be referred to as first and second hash tree, respectively, in the context of this application. In some instances it might be necessary to include parameters used in the computation of the first hash tree in the first summary information 107 for allowing the computation of the second hash tree.

It is possible that only the hash value associated with a root node 403 is stored in the master tag 106 as first summary information 107. Consequently, by rebuilding the second hash tree 400 using the verification system 100 and comparing the hash value of the computed root node 403 of the second group of tag items 201 with a root hash value of the first hash tree comprised in the first summary information 107 and associated with the first group of tags 200, it is possible to detect whether the first and second group of tags 200 and 201 are identical or not.

Although, in theory different hash trees 400 could result in the same hash value at the root node 403, due to the properties of the hash functions g and h, it is extremely unlikely that adding, replacing or removing individual tags 105 from the second group of tags 201 with respect to the first group of tags 200 will result in an identical root hash value. For cryptographic hash functions, the art considers it infeasible for a malicious party to add or remove tags and still be able to obtain the same root hash value.

It should be noted that, although the hash tree 400 shown in FIG. 4 only comprises eight leaf nodes 401, having a tree depth of 3, in practice, a hash tree 400 of a sizable first group of tags 200 may comprise many or a few thousand nodes 401 and 402. In such circumstances it may be impossible to store the entire hash tree 400 as part of the first summary information 107.

Storing the root node 403 alone only allows detecting whether or not the first group of tags 200 is identical to the second group of tags 201. However, it may be desirable to track changes between the first group of tags 200 and the second group of tags 201 in more detail. For example, it may be desirable to know which tags 105a or 105b have been removed or added to the second group of tags 201, respectively.

In order to allow such operations, additional information about the hash tree 400 can be stored as part of the first summary information 107. For example, the hash values associated with at least some of the internal nodes 403 of the first hash tree may be stored.

If, for example, only the hash values associated with internal nodes 402 of depth 1 of the first hash tree are stored, i.e. the hash values labeled H5 and H6 in FIG. 4, it is possible to detect whether a tag 105 mapped to one of the leaf nodes L1 to L4 or to one of the leaf nodes L5 to L8 by the first hash function h has been added or removed.

Assuming, that an item 104 whose tag 105a is associated with leaf node L2 has been removed from the second group of tags 201 with respect to the first group of tags 200, then the internal node 402, labeled H5, of the second hash tree will almost certainly comprise a different hash value than that of the first hash tree. Conversely, the hash value associated with the internal node 402 labeled H6 will be identical for the first hash tree and the second hash tree. Thus, when comparing hash values associated with corresponding nodes 402 of the first and second hash trees it is possible to check in which part of a hash tree 400 a change has occurred.

According to a further embodiment, the hash values of all internal nodes 402 are stored in the first summary information 107. This allows determining places of the first and second hash trees where changes have occurred.

According to another embodiment only hash values associated with a predefined depth, e.g. only nodes 401 comprised in a top or bottom part of the hash tree 400, are stored in the first summary information 107. By storing only a few hash values in the first summary information 107, the storage requirements for the first summary information 107 can be greatly reduced. In general, there will be a tradeoff between the precision with which a change in the hash tree 400 can be traced and the storage requirement for the first summary information 107.

According to a second variant, tags 105 which have been added, removed or replaced in the second group of tags 201 with respect to the first group of tags 200 can be further tracked using a probabilistic approach based on the buckets 300 computed using the first hash function h. In general, the second approach reduces the amount of information that needs to be stored for locating added or removed tags, at the expense of decreased discriminatory power, as detailed below.

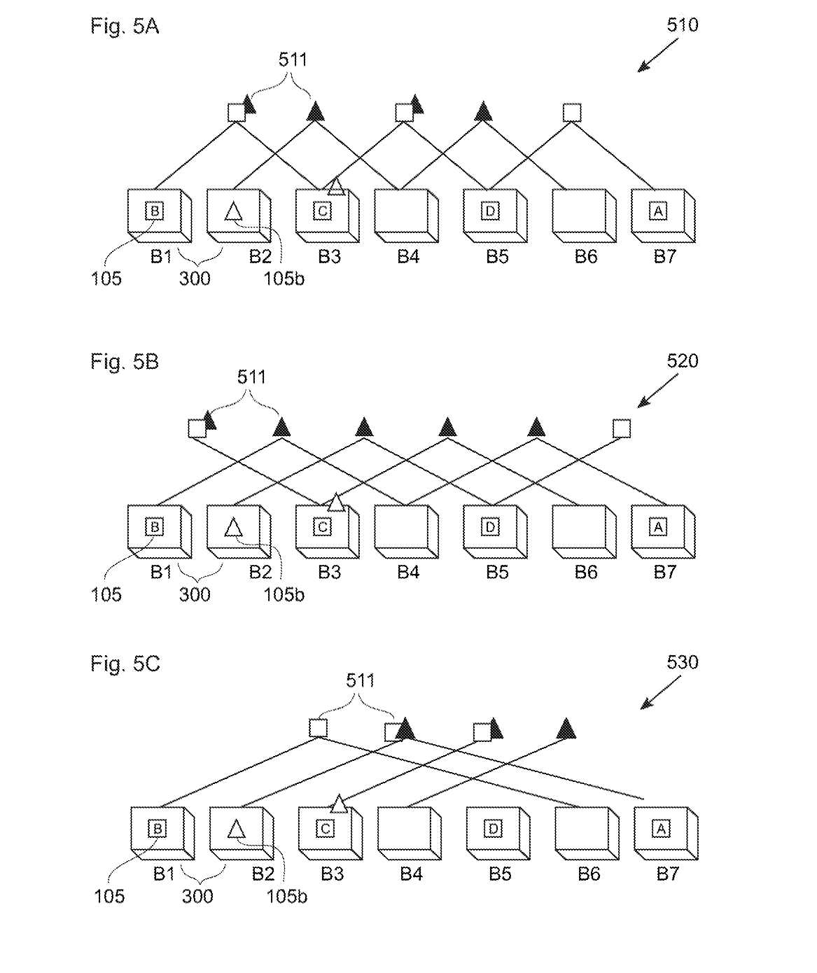

FIG. 5A to FIG. 5C show different hash structures that have been computed using different tree levels. These will be referred to as “partial hash trees” or “hash forests” 510, 520 and 530 within the scope of this description.

In practice, two tag values 105 of the second group of tag values 201, referred to as “child nodes” and determined by the order of the buckets 300, are combined to compute a hash value 511, referred to as “parent node”, based on a second hash function g. In this context, the term “tree level” relates to the distance between any two buckets 300 to be combined by a common parent node for the purpose of computing a hash value 511, as detailed below.

The hash forest 510 shown in FIG. 5A has the tree level 2, such that a hash value 511 is computed for the combination of bucket B1 and bucket B3, bucket B2 and bucket B4, bucket B3 and bucket B5 and so on. The hash forest 520 shown in FIG. 5B has the tree level of 3, such that hash values 511 are computed based on the bucket B1 and bucket B4, bucket B2 and bucket B5 and so on. The hash forest 530 shown in FIG. 5C has the tree level of 5, such that hash values 511 are computed based on bucket B1 and bucket B6, bucket B2 and bucket B7 and so on. In general, hash forests with a tree level equaling a prime number will result in hash forests comprising hash values 511 which are unrelated to one another.

In the presented example, squares represent tags 105 and associated hash values 511 of the second group of tags 201 which were already part of the first group of tags 200. Triangles represent tags 105b and associated hash values 511 that have been added to the second group of tags 201 and thus should be identified as incorrectly added tags 105b.

According to the example presented in FIG. 5A, the verification system 100 can deduce that the tags 105 labeled B, C, D and A comprised in the buckets B1, B3, B5 and B7 respectively are tags 105 that were included in the first group of tags 200. In addition, the verification system 100 can deduce that the tag added to bucket B3 is an added tag 105b.

From the hash forest 520 shown in FIG. 5B the verification system 100 can deduce that the tag 105b comprised in bucket B2 does not belong to the first group of tags 200. In addition, it can hypothesize that the tag 105 labeled D and comprised in bucket B5 is a tag 105 already comprised in the first group of tags 200. There is further evidence that the tags 105 labeled C and D respectively are also valid tags 105.

The hash forest 530 comprised in FIG. 5C further strengthens the hypothesis that the tag 105 labeled B is a valid tag. There is also further evidence that the tag 105 labeled C is valid, and that the tag 105b comprised in bucket B3 is an added tag 105b.

Due to the properties of the second hash function g, each matching hash value 511 will add probabilistic evidence that the nodes attached to it have not been tampered with. Thus, by relating the different hash forests 510, 520 and 530 with one another, a combined probability for each tag 105 comprised in each bucket 300 can be inferred. By this means, even only very short hash values 511 of hash forests 510, 520 and 530 are stored as part of the first summary information, i.e. if the second hash function g has a very high compression ratio, 107, individual hash values comprised in the buckets corresponding to original tags 105 and added tags 105b can be detected and distinguished with high likelihood.

In practice, the length m of the hash values produced by the second hash function g in order to build the hash forests 510, 520 and 530, the number of hash values stored for each hash forest 510, 520 and 530 and the number of hash forests 510, 520 and 530 having different tree levels to be computed can be varied to match a predetermined requirement profile. In particular, if a predefined probability of detecting an added, replaced or removed tag 105 is given, the different parameters used in the creation of the hash forests 510, 520 and 530 and resulting first summary information 107 can be adapted accordingly.

In summary, one method in accordance with an embodiment of the invention comprises the following steps:

Part (a): Error detection for removed tags and enforcement of a canonical order of tags 105

Assuming S is a first group of tags 200 with n tags 105 and 105a, of which t tags 105 could be read by tag reader 101.

The tag reader 101 reads all t tags 105 readable plus the master tag 106.

The tag reader 101 determines the key of the perfect hash function h stored by the master tag 106. Alternatively, a publicly known hash function h could be used, e.g. a hash function h defined by a pre-defined system parameter of a standardized procedure.

The reader hashes all tags 105 read into n of N buckets 300 using the perfect hash function h.

The tags 105 are now ordered according to the order of the buckets 300.

Phase (b): Integrity check in presence of replaced or added tags 105b

Assuming that tags 105b not element of S are distributed pseudo-randomly over the buckets 300, there are two alternative cases to be considered:

Case 1: An added tag 105b hits a bucket 300, filled with a tag 105 belonging to S. Then a collision is detected. The probability for this case is t/N.

In this case, the collision reveals that a tag 105 was added. The method still needs to decide which tag 105 in the bucket belongs to S.

Case 2: An added tag 105b hits an empty bucket 300, belonging to a tag 105a in S that could not be read. The probability for this event is: P_{empty}=1−t/N

So far, the validation depends on the first hash function h only. In the following, a second hash function g is used in order to derive additional hash values 511, relating to the probabilistic approach described above:

Compute small hash values 511 using a second hash function g with a length of m bit for all tags 105 read by the tag reader 101. Do this according to the following scheme:

### For a sub-scheme with number i skip each ith tag 105 in the buckets 300 and compute the hash value of all such pairs of tags 105. Shift the scheme such that all tags 105 are covered.

Evaluate this sub-scheme for the first d prime numbers i corresponding to the depth. If several tags are in the same bucket compute each combination of one tag in the bucket with its neighbors.

Compare the hash values 511 computed in step 5 with the pairs of hash values stored on the master tag 106. Note that the hash values 511 have a very small length m.

The verifier 102 now computes the interferences between all the hash values computed and generates hypotheses as to which tags 105 are “good”, i.e. were already comprised in the first set of tags 200, and which are “bad”, i.e. correspond to added tags 105b, according the following rules:

Assuming that the error probability of the second hash function g is dependent on its length m, i.e. P_{g,err}=f(m), the following base predicates hold:

If a pair names the correct value, the tag 105 is assumed to be “good”. For two tags t1, t2 and a hash value g(t1∥t2) and a stored hash value gₘ on the master tag 106, the following holds:

g(t1∥t2)=gₘ→P[(good(t1)AND good(t2))]=1−P_{g,err}

If a pair results in an incorrect value on any level, at least t1 or t2 are “bad”. For two tags t1, t2 and a hash value g(t1∥t2) and a stored hash value gₘ on the master tag 106, the following holds:

g(t1∥t2)≠gₘ→P[(NOT good(t1)OR NOT good(t2))]=1

If one of such tags, for example, without limiting on generality, t1, is assumed to be “good” on any level, assume t2 is “bad”. For three tags t1, t2 and t3 and hash values g(t1∥t2) and g(t2∥t3) as well as stored hash values gₘ₁ and gₘ₂ on the master tag 106, the following holds:

g(t1∥t2)≠gₘ₁AND g(t2∥t3)=gₘ₂→P[NOT good(t1)]=1−P_{g,err}

From the interferences of all the hash values 511, the verifier 102 can deduce which tags 105b do not belong to the first group of tags 200. The verifier 102 may cumulate the probabilities from different hash forests 510, 520 and 530 having different tree levels for a single tag 105. If a hash value 511 reaches a predefined threshold it is considered “good”.

Note that the number a of replaced or added tags 105b is assumed to be very small compared to the number of good tags 105, i.e., a<<n. Because of this, the Boolean equation resulting from the interferences will contain many “good” hash values 511 and only a few “bad” hash values 511. Thus, the equation can be collapsed easily and is not too complex to solve.

Phase (c): Further refinement in case of many added, removed or replaced tags

In general, the error probability for the whole approach to detect added tags 105b can be approximated by P_{empty}*(P_{g,err})^{d}, where P_{empty} is the probability for an added tag 105b to hit an empty bucket 300, P_{g,err} is the error probability of the second hash function g and d is the number of prime levels used. For a number of added tags a>p where p is the largest prime number used, there is a very small probability that 2·p “bad” tags 105b are hashed into adjacent buckets 300 by a perfect hash function h. In this case, the solution fails to point out “good” tags hidden in this group. For special cases better approximations exist, though these are beyond the scope of the present application.

For further improvement of the error probability, repeat the steps 1-6 for a different key for the perfect hash functions h or hash function g and other small hash values 511. Then, the tags 105 are permutated pseudo-randomly over the buckets 300. Thus, one can compute interferences between the hash forests 510, 520 and 530 of the first and the second iteration. The error probability of the solution is then reduced significantly.

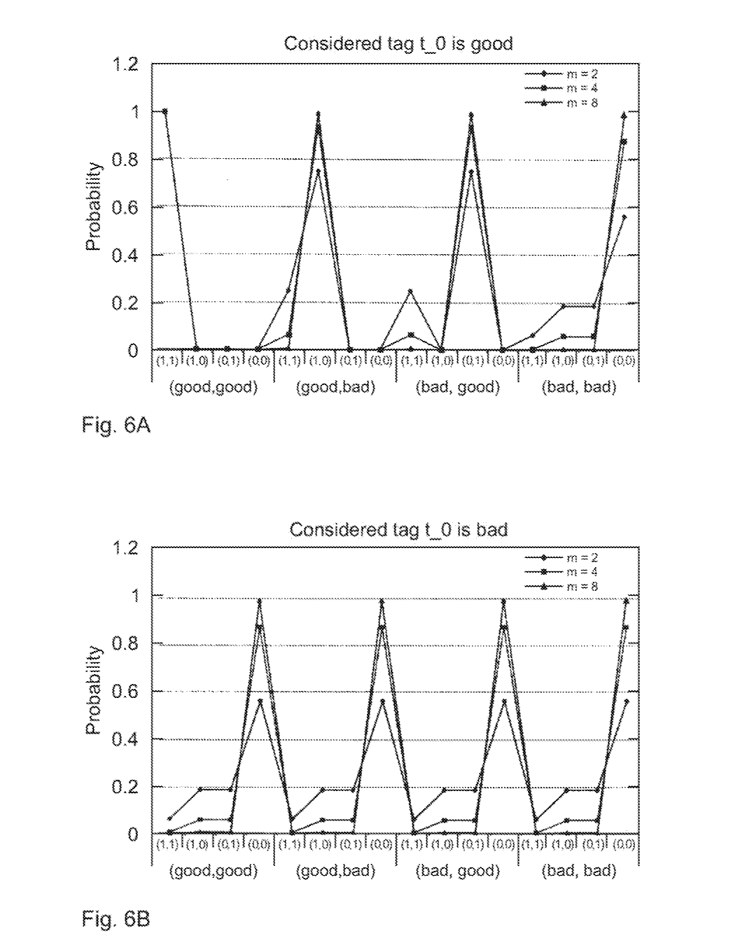

FIG. 6A and FIG. 6B show the discriminatory power of the proposed scheme for different hash value length m of the second hash function g. As for FIG. 6A, a centre tag 105 comprised in an underlying bucket 300 is considered to be correct, i.e. part of the first group of tags 200. As for FIG. 6B, the center tag 105b comprised in an underlying bucket 300 is considered to be incorrect, i.e. not part of the first group of tags 200. In both diagrams, the joint probabilities derived using the interference of two hash forests 510 and 520 with different tree levels for adjacent tags 105 left and right of the center tag are shown.

In FIG. 6A, one specific tag 105 is selected for the purpose of analysis. With reference to FIG. 5A and FIG. 6A, bucket B3 will be considered by way of example here. It contains two tags, let the good one be t_0A and the bad one t_0B.

FIG. 6A refers to the situation in which a good tag, i.e. t_0A, is in the center of pairings with other tags 105. In FIG. 5A, for example t_0A is paired with the tags 105 from B1 and B5. Both other tags 105 are good, i.e. have the case (good, good), represented by the group of four data points on the left of FIG. 6A. For this case one gets a probability of 1 that the comparison of the hash values 511 of the second hash function g with the values stored in the first summary information 107 outputs (1, 1), represented by the leftmost data point, and a probability of 0 for the remaining three data points of the left group.

FIB 6B refers to the situation in which the center tag 105b is bad, i.e. corresponding to tag t_0B. This tag 105 is again paired with the tags 105 from B1 and B5 for the comparison with the first summary information 107. Now a bad tag 105b in the center is paired with two good tags 105 (good, good) as shown by the left group of four data points of FIG. 6B. It can be seen that the result (0, 0), corresponding to the fourth data point from the left, will be outputted with a very high probability. However, there is a small probability that higher comparison values, corresponding to the first three data points, are returned, indicating correct tags 105 even in case an incorrect tag 105b is present. This means: a bad tag 105b results in a high probability for pairings with adjacent tags 105 to produce low comparison value for comparison with the first summary information 107, i.e. that it results in a trace of zeros for different hash forests 510, 520 and 530.

As can be seen from FIG. 6A, a high probability exists for each combination of adjacent tags 105 to be identified correctly. The level of the computed probability increases with increased length m of the hash values 511, resulting in a probability of over 99% for m=8.

In the case presented in FIG. 6B, i.e. in case of an incorrect center tag 105b, the resulting probabilities is always highest for the result (0,0), i.e. it indicates the presence of an error in the triple of tags 105 verified.

In conclusion, the verification scheme presented above makes correct predictions in case of correct center tags 105 and distinctively indicates areas in which an added, removed or replaced tag 105a or 105b is present. Both events are detected with a relatively high probability.

Assuming a first group of tags 200 with size n=1000 corresponding to 1000 tags 105, a depth d=3 corresponding to the number hash forests 510, 520 and 530 with different hash levels of 2, 3 and 5, and a hash value length m=4 bit, the total storage requirement for the resulting first summary information 107 is given by

n·d·m=1000−3·4bit=12000bit=1.5kByte,

which can be stored in industrially available master tags 106 with advanced storage capacity. In consequence, it is possible to store all information required by a verification device 100 together in a master tag 106, such that no online database connection is required by the verification system 100.

Many alterations may be applied by a person skilled in the art without departing from the spirit of the invention. Thus, the scope of this patent shall not be restricted by the exemplary embodiments described above, but only the patent claims set out below.

That which is claimed is:

1. A verification method comprising:
reading first summary information related to a first group of tags;
reading tag information for each tag of a second group of tags;
computing second summary information based on the read tag information of the second group of tags;
comparing the first summary information and second summary information; and
verifying whether the first group of tags and the second group of tags are identical based on the comparison.

2. The verification method according to claim 1, wherein the first summary information is read from a master tag associated with the first group of tags.

3. The verification method according to claim 1, wherein the first summary information and the second summary information is based on at least one hash function (g, h) resulting in a hash value for each tag information.

4. The verification method according to claim 3, wherein the at least one hash function (g, h) is a predefined hash function (g, h).

5. The verification method according to claim 3, wherein the at least one hash function (g, h) is a parameterized hash function (g, h) and at least one parameter used by the hash function (g, h) is comprised in the first summary information.

6. The verification method according to claim 5, wherein:
the at least one hash function (h) is a perfect hash function resulting in a unique hash value for each tag of the first group of tags; and
in the step of computing the second summary information, a collision of hash values computed for two different tags of the second group of tags indicates an addition of an extra tag to the second group of tags.

7. The verification method according to claim 1, wherein:
the first summary information and the second summary information comprises a multiplicity of values associated with a multiplicity of sub-groups of the first group of tags and the second group of tags, respectively;
in the step of comparing, pairs of values from the first summary information and second summary information are compared with each other; and
in the step of verifying, identical and modified pairs of values of the first summary information and second summary information are identified, corresponding to unmodified and modified pairs of sub-groups of the first and second group of tags, respectively.

8. The verification method according to claim 7, wherein:
the first summary information comprises data values related to at least a sub-group of nodes of a first hash tree;
in the step of computing the second summary information, at least one second hash tree is computed; and
in the step of comparing, corresponding tree nodes of the first and second hash trees are compared with each other.

9. The verification method according to claim 7, wherein:
the first summary information comprises data values related to at least a sub-group of nodes of at least two different first hash forests with a first and a second tree level;
the step of computing is performed at least twice for computing at least two different second hash forests with a first and second tree level;
the step of comparing is performed at least twice using the pairs of first and second hash forests with the first and second tree level, respectively, resulting in first and second probability values for different sub-groups of the second group of tags being modified; and
in the step of verifying, a combined probability value for each tag of the second group of tags being computed based on the interference of the first and second probability values associated with the tag to be verified.

10. A verification system comprising:
a tag reader for wirelessly reading first summary information related to a first group of tags from a master tag and tag information from each tag of a second group of tags; and
a verifier operationally connected with the tag reader for:
reading the first summary information from the master tag;
reading tag information from the tags of the second group of tags;
computing second summary information based on the read tag information;
comparing the first summary information and the second summary information; and
verifying whether the first group of tags and the second group of tags are identical based on the comparison.

11. The verification system according to claim 10, wherein:
the verifier is further configured to detect the absence of a tag from the second group of tags with respect to the first group of tags; and
on detection of the absence of at least one tag, the reader is repositioned with respect to the second group of tags for further reading of the tags.

12. A computer program stored in computer readable memory comprising program instructions that, on execution using a processing device of a verification system perform the steps of:
reading first summary information related to a first group of tags;
reading tag information for each tag of a second group of tags;
computing second summary information based on the read tag information of the second group of tags;
comparing the first summary information and the second summary information; and
verifying whether the first group of tags and the second group of tags are identical based on the comparison.
